(19) United States
(12) Patent Application Publication
(10) Pub. No.: US 2015/0340058 A1
(43) Pub. Date: Nov. 26, 2015

(54) ROTATING DEVICE

(71) Applicant: Samsung Electro-Mechanics Japan Advanced Technology Co., Ltd., Shizuoka (JP)

(72) Inventors: Hiromitsu GOTO, Shizuoka (JP); Yuuji NISHITANI, Shizuoka (JP); Naoki SHINJI, Shizuoka (JP)

(73) Assignee: Samsung Electro-Mechanics Japan Advanced Technology Co., Ltd.

(21) Appl. No.: 14/711,884

(22) Filed: May 14, 2015

(30) Foreign Application Priority Data
May 23, 2014 (JP) 2014-107504
Jul. 22, 2014 (JP) 2014-149201

(51) Int. Cl. G11B 19/20

(52) U.S. Cl. CPC G11B 19/2045

(57) ABSTRACT

A rotating device includes: a hub mounting a recording disk; a base rotatably supporting the hub via a bearing, a core fixedly mounted on the base, and having a circular portion and salient poles protruding radially outward; a coil wound around the salient poles; and an FPC including driving lines. The base has a wire hole that communicates between an upper face that faces the coil in the axial direction and an opposite lower face. The lower face has a bottom recess portion surrounding a hub rotational axis, and regions facing each other across the rotational axis. The FPC includes an arc section housed in the bottom recess portion. Each lead wire is drawn out from the coil to the lower-face side via the wire hole, and is connected to the driving line on a connection land formed at an interval from the wire hole in the circumferential direction.

### BACKGROUND OF THE INVENTION

1. Field of the Invention

The present invention relates to a rotating device which rotationally drives a recording disk.

2. Description of the Related Art

As an example of a rotating device, disk drive apparatuses such as hard disk drives are known. Progress is being made in reducing the size, the thickness, and the weight of such a disk drive apparatus. Such a disk drive apparatus is mounted on various kinds of electronic devices.

In particular, progress is being made in mounting such a disk drive apparatus in electronic devices such as laptop personal computers, video recorders, and so forth. Conventionally, a disk drive apparatus has been proposed as described in Japanese Patent Application Laid Open No. 2012-172781, for example.

### SUMMARY OF THE INVENTION

With such a disk drive apparatus described in Japanese Patent Application Laid Open No. 2012-172781, a terminal of a wire that forms a coil is drawn out on the lower face side of a base, and is soldered on a flexible printed circuit board adhered to the lower face of the base. Typically, such a flexible printed circuit board is housed in a recess formed in the lower face of the base such that it does not protrude downward from the lower face of the base. In some cases, the peripheral wall of the recess leads to a difficulty in soldering depending on the soldering position. This leads to a disadvantage from the viewpoint of production efficiency.

Such a problem is not restricted to such a disk drive apparatus. Rather, various kinds of other rotating devices can have such a problem.

The present invention has been made in view of such a situation. Accordingly, it is a general purpose of the present invention to provide a rotating device which provides improved production efficiency.

In order to solve the aforementioned problem, a rotating device according to an embodiment of the present invention comprises: a hub on which a recording disk is to be mounted; a base that rotatably supports the hub via a bearing, a stator core fixedly mounted on the base, and having a circular portion and multiple salient poles each protruding radially outward from the circular portion; a coil formed by winding a wire around the multiple salient poles; and a circuit board including a driving line. The base is provided with a wire hole that communicates between a first face that faces the coil in the axial direction and a second face that is opposite to the first face. The second face is provided with a surrounding recess portion having an arc region formed in an approximately arc shape, which is configured to surround a rotational axis of the hub and to have regions that face each other across the rotational axis. The circuit board comprises an arc section formed in an approximately arc shape, which is housed in the arc region. A lead wire is drawn out from the coil to the second face side via the wire hole, and is connected to the driving line on a connection land formed in the arc section at an interval from the wire hole in a circumferential direction.

Optional combinations of the aforementioned constituting elements and implementations of the invention in the form of methods, apparatuses, or systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1A and FIG. 1B are a top view and a side view showing a rotating device according to an embodiment;

FIG. 2 is a cross-sectional view taken along line A-A in FIG. 1A;

FIGS. 3A and 3B are a top view and a bottom view showing a chassis and a base;

FIG. 4 is a top view showing the base and its surroundings;

FIG. 5 is a bottom view showing the base and its surroundings;

FIG. 6 is a bottom view showing the base and its surroundings;

FIG. 7 is a cross-sectional view taken along line B-B in FIG. 6;

FIG. 8 is an explanatory diagram for describing the structures of a wire hole, a notch formed in an insulator sheet, and a notch formed in an FPC, and the position relation among them;

FIG. 9A is a cross-sectional view taken along line C-C in FIG. 8, and FIG. 9B is a cross-sectional view taken along line D-D in FIG. 8; and

FIG. 10 is a diagram showing a bottom recess portion formed in the base according to a modification.

### DETAILED DESCRIPTION OF THE INVENTION

The invention will now be described by reference to the preferred embodiments. This does not intend to limit the scope of the present invention but to exemplify the invention. The size of the component in each figure may be changed in order to aid understanding. Some of the components in each figure may be omitted if they are not important for explanation.

A rotating device according to an embodiment may preferably be employed as a disk driving apparatus, and particularly, as a hard disk drive mounting a magnetic recording disk and configured to rotationally drive the magnetic recording disk.

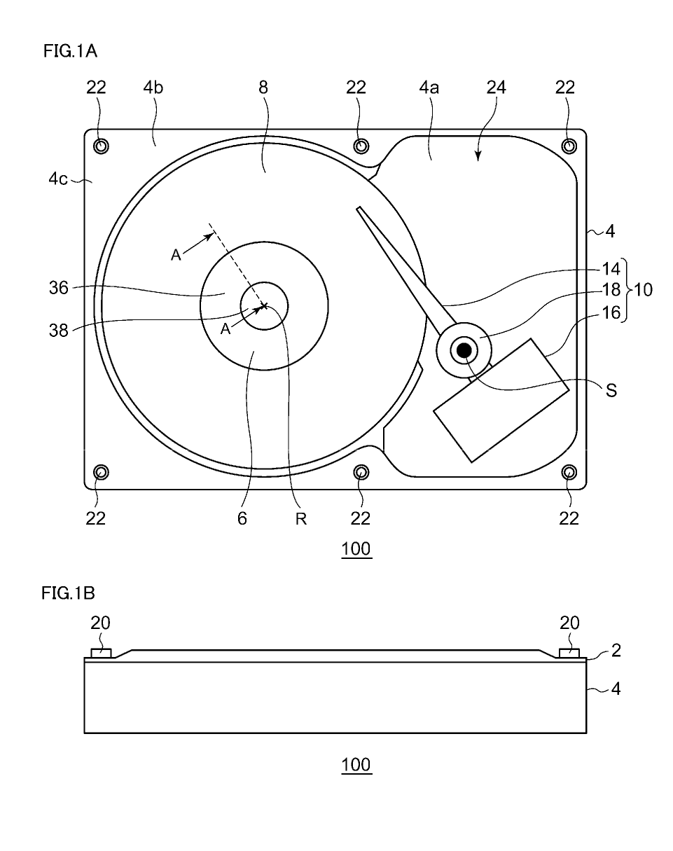

FIGS. 1A and 1B each show a rotating device 100 according to an embodiment. FIG. 1A is a top view of the rotating device 100. FIG. 1B is a side view of the rotating device 100. In order to show the internal structure of the rotating device 100, FIG. 1A shows a state without a top cover 2. The rotating device 100 includes a stator, a rotor which rotates with respect to the stator, a magnetic recording disk 8 mounted on the rotor, and a data read/write unit 10. The stator includes a chassis 4, a top cover 2, and six screws 20. The rotor includes a clamper 36 and a disk fixation screw 38. Description will be made below with the side of the chassis 4 on which the rotor is mounted as the upper side. Also, description will be made below with the direction that is parallel with the rotational axis R of the magnetic recording disk 8 as the axial direction, with an arbitrary direction that passes through the rotating axial R on a plane that is orthogonal to the rotational axis R as the radial direction, with the side farther from the rotational axis R in the radial direction as the outer side, with the side closer to the rotational axis R as the inner side, and the direction along the circumference of a circle having the rotational axis R as a center, which is orthogonal to the rotational axis R, as the circumferential direction. Any description using such directions and sides is by no means intended to restrict the orientation of the rotating device 100 in operation. The rotating device 100 may be operated in a desired orientation.

The magnetic recording disk 8 is configured as a 2.5-inch magnetic recording disk formed of a glass disk having a diameter of 65 mm, a central hole with a diameter of 20 mm, and a thickness of 0.65 mm. In FIG. 1, the magnetic recording disk 8 is mounted on the hub 28 (not shown), and is rotated according to the rotation of the hub 28. The clamper 36 is pressed in contact with the upper face of the hub 28 by means of the disk fixation screw 38. With such an arrangement, the clamper 36 presses the magnetic recording disk 8 in contact with the disk mounting face of the hub 28.

The chassis 4 is formed by molding an aluminum alloy material by means of die casting. The chassis 4 includes a bottom portion 4a having an approximately rectangular shape as viewed in a plan view so as to define the bottom of the rotating device 100, and an outer wall portion 4b formed along the outer edge of the bottom portion 4a so as to surround a mounting region on which the magnetic recording disk 8 is to be mounted. Six screw holes 22 are formed in the upper face 4c of the outer wall portion 4b. The chassis 4 may be formed by press forming a steel plate or aluminum plate.

The data read/write unit 10 includes a record and playback head (not shown), a swing arm 14, a voice coil motor 16, and a pivot assembly 18. The record and playback head is arranged at the end of the swing arm 14, and is configured to record data on the magnetic recording disk 8, and to read out data from the magnetic recording disk 8. The pivot assembly 18 supports the swing arm 14 such that it can be freely swung around the head rotational axis S with respect to the chassis 4. The voice coil motor 16 swings the swing arm 14 around the head rotational axis S, such that the record and playback head is shifted to a desired position above the upper face of the magnetic recording disk 8. The voice coil motor 16 and the pivot assembly 18 are each configured using known techniques for controlling the head position.

The top cover 2 is fixedly arranged on the upper face 4c of the outer wall portion 4b of the chassis 4 using the six screws 20. The six screws 20 respectively correspond to the six screw holes 22. Specifically, the top cover 2 and the upper face 4c of the outer wall portion 4b are fixedly coupled to each other such that no leaks to the interior of the rotating device 100 arise via the connection between them. Here, the interior of the rotating device 100 is a clean-air space 24 surrounded by the bottom portion 4a of the chassis 4, the outer wall portion 4b of the chassis 4, and the top cover 2. The clean-air space 24 is designed so as to be configured as an airtight space such that there is no leak-in from the exterior and no leak-out to the exterior. The clean-air space 24 is filled with clean air from which particles have been removed. Such an arrangement protects the magnetic recording disk 8 from the adherence of contaminants, thereby providing the operation of the rotating device 100 with improved reliability.

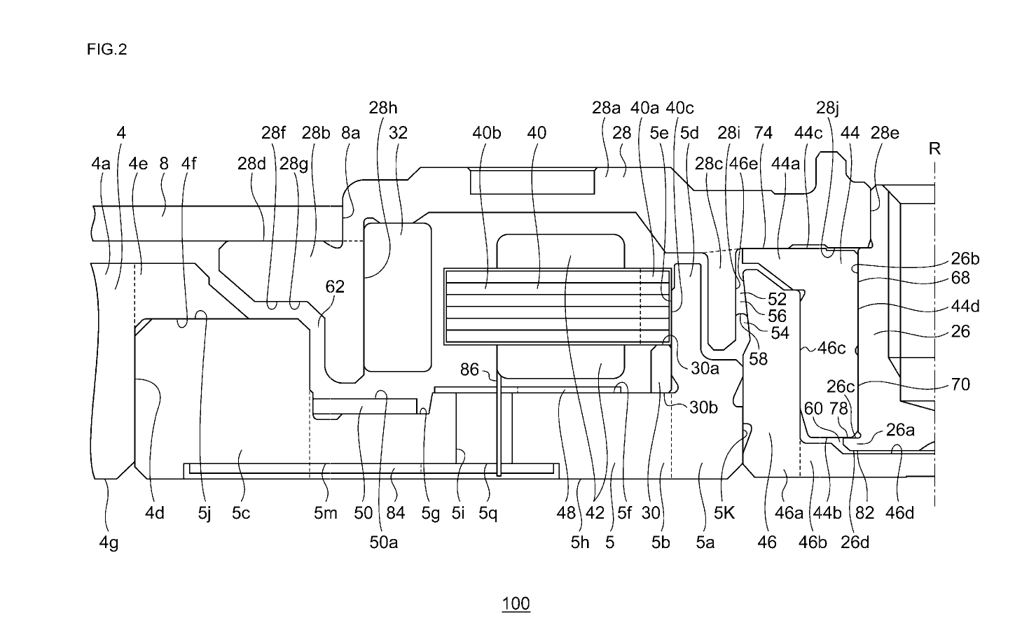

FIG. 2 is a cross-sectional view taken along line A-A in FIG. 1A. The cross-sectional view shown in FIG. 2 corresponds to a half part of the cross-section of a driving unit of the rotating device 100. In FIG. 2, the clamper 36 and the disk fixation screw 38 are not shown. The rotor further includes a shaft 26, a hub 28, and a magnet 32. The stator further includes a base 5, a core supporter 30, a stator core 40, a coil 42, a sleeve 44, a housing 46, an insulator sheet 48, an attracting plate 50, and a flexible printed circuit board (which will be referred to as the “FPC” hereafter) 84. A lubricant agent 52 is continuously interposed in a part of the gap between the rotor and the stator.

The hub 28 is configured to have a predetermined approximately cup-shaped form by machining or press forming a steel material such as SUS430 or the like configured as a soft magnetic material, or otherwise by machining such a steel material after it is press formed. In order to prevent the detachment of the surface layer of the hub 28, the hub 28 may be subjected to surface coating such as electroless nickel plating.

The hub 28 has a hub protrusion portion 28a which is to be fitted into a central hole 8a of the magnetic recording disk 8, a disk mounting portion 28b configured such that it extends from the hub protrusion portion 28a along the radial direction, and a downward protruding portion 28c configured such that it protrudes downward from the lower face 28j of the hub protrusion portion 28a so as to surround the housing 46. The magnetic recording disk 8 is mounted on the disk mounting face 28d configured as an upper face of the disk mounting portion 28b. The magnetic recording disk 8 is mounted such that it is interleaved between the clamper 36 (not shown in FIG. 2) and the disk mounting portion 28b, thereby fixedly mounting the magnetic recording disk 8 with respect to the hub 28.

A part of the lower face 28f of the disk mounting portion 28b on the outer side in the radial direction defines a ring-shaped hub recess 28g that is recessed upward in the axial direction. In other words, another part of the lower face 28f of the disk mounting portion 28b on the inner side in the radial direction defines a ring-shaped protrusion that protrudes toward the base 5.

The shaft 26 is formed by cutting, polishing, or otherwise grinding a steel material such as SUS420J2 or the like, having a hardness that is higher than the raw material of the hub 28. The shaft 26 is arranged such that it extends along the rotational axis R as the center. A shaft hole 28e is formed in the hub protrusion portion 28a with the rotational axis R as the center. The upper end of the shaft 26 is inserted into the shaft hole 28e, and is fixed by means of adhesion or press fitting, or otherwise both. The shaft 26 has a ring-shaped flange portion 26a on the lower end side such that it extends outward in the radial direction.

The magnet 32 is configured as a cylindrical member which is fixedly bonded to a cylindrical inner face 28h that corresponds to the inner-side cylindrical face of the hub 28. The magnet 32 includes a neodymium rare earth magnet material, for example. Also, the magnet 32 may include other kinds of rare earth magnet materials or ferrite magnet materials. The magnet 32 may include a binder such as polyamide resin. The magnet 32 is arranged such that it faces nine salient poles 40b of the stator core 40 in the radial direction. The magnet 32 is provided with twelve driving magnetic poles along its circumferential direction. A surface film is provided to the surface of the magnet 32 by means of electro-coating, spray coating, or the like.

The stator core 40 has a circular portion 40a and nine salient poles 40b, each protruding radially outward from the circular portion 40a. The stator core 40 is formed by laminating 2 to 32 thin magnetic steel sheets each having a thickness ranging between 0.1 mm and 0.8 mm, for example. With the present embodiment, the stator core 40 is formed by laminating and swaging six thin magnetic steel sheets each having a thickness of 0.35 mm, so as to form a single member. A surface film is provided to the surface of the stator core 40 by means of electro-coating, powder coating, or the like. The coil 42 is wound around each salient pole 40b of the stator core 40. By applying a three-phase driving current having an approximately sinusoidal waveform to the coil 42, such an arrangement is capable of generating a driving magnetic flux along each salient pole 40b. It should be noted that the stator core 40 may be formed by solidifying magnetic powder in the form of a sintered compact, for example.

The coil 42 is formed by winding a wire around each salient pole 40b of the stator core 40 a required number of times. The wire is wound around a given salient pole 40b with the lower side as the winding start position. Subsequently, with such an arrangement configured to perform a three-phase driving operation, the wire is successively wound around the next salient pole that is to function as the same phase pole as the previous salient pole, with the upper side as the winding start point. After the wire is wound, the wire (which will be referred as the “lead wire 86” hereafter) is drawn out on the lower side of the salient pole 40b.

The base 5 is formed by cutting a base material configured as a non-magnetic stainless steel such as SUS303 or the like. Also, the base 5 may be formed by press forming such a base material, and by cutting the base material thus press formed. The base 5 includes an inner portion 5a configured to surround the housing 46, an intermediate portion 5b configured to surround the inner portion 5a, and an outer portion 5c configured to surround the intermediate portion 5b. The base 5 may be formed of an aluminum alloy material so as to form a single unit together with the chassis 4.

The inner portion 5a has a ring-shaped base protrusion portion 5d with the rotational axis R as its center. The base protrusion portion 5d is configured such that it protrudes toward the hub 28 side so as to surround the housing 46. By fitting the central hole 40c defined by the circular portion 40a of the stator core 40 to the outer face 5e of the base protrusion portion 5d, the stator core 40 is fixed to the base 5. Specifically, the circular portion 40a of the stator core 40 is fixedly bonded to the base protrusion portion 5d by press fitting or otherwise by running fitting. The adhesive agent used to fix the stator core 40 may contain a fluorescent material.

The intermediate portion 5b is arranged such that it faces the stator core 40, the coil 42, and the magnet 32 in the axial direction. The intermediate portion 5b has a flat upper face 5f. An insulator sheet 48 formed of a resin such as PET or the like is provided to a part of the upper face 5f of the intermediate portion 5b that faces the stator core 40 and the coil 42 in the axial direction.

Four wire holes 5i are formed in the intermediate portion 5b such that the upper face 5f communicates with the lower face 5h, which is opposite to the upper face 5f. The lead wire 86 is drawn out to the lower face 5h side of the base 5 via the corresponding wire hole 5i.

A ring-shaped base recess portion 5g is formed on the outer side of the intermediate portion 5b in the radial direction with the rotational axis R as the center. The base recess portion 5g is configured such that it is recessed downward. At least a part of the base recess portion 5g is arranged such that it faces the magnet 32 in the axial direction. The base recess portion 5g is provided with the ring-shaped attracting plate 50 formed of a magnetic material such as iron. The attracting plate 50 is fixedly mounted on the bottom of the base recess portion 5g by swaging or bonding. The base recess portion 5g and the attracting plate are configured such that the upper face 50a of the attracting plate 50 does not project beyond the upper face 5f of the intermediate portion 5b in a state in which the attracting plate 50 is housed in the base recess portion 5g. The magnetic attracting plate 50 is attracted to the magnet 32 by magnetic attraction force. Thus, a downward force is applied to the magnet 32 in the axial direction. This force prevents the rotor from rising up when it is rotationally driven.

The outer portion 5c is formed such that it protrudes upward and projects beyond the upper face 5f of the intermediate portion 5b. A part of the outer portion 5c is inserted into the hub recess 28g. This provides a gap 62 between the outer portion 5c and the disk mounting portion 28b with a comparatively narrow width and a long interval, and with a curved portion. That is to say, this provides the gap 62 with a passage resistance that is comparatively large. Thus, the gap 62 functions as a labyrinth with respect to the vapor of a lubricant agent 52 that evaporates from a gas-liquid interface 58 (described later). Such an arrangement prevents the lubricant agent 52 gas from reaching the magnetic recording disk 8.

A bottom recess portion 5m is formed in the lower face 5h of the base 5. The bottom recess portion 5m is configured such that it is recessed upward. The bottom recess portion 5m houses a part of the FPC 84. The lead wire 86 is bent above the wire hole 5i, is arranged such that it extends along the lower face 5h of the base 5, and is electrically connected to the corresponding driving wiring of the FPC 84. This connection is made by soldering.

The core supporter 30 is a cylindrical member formed of a resin that is more flexible than the base 5, examples of which include polyacetal, PBT (polybutylene terephthalate resin), and the like. The core supporter 30 is fixed to the outer face 5e of the base protrusion portion 5d by means of adhesion, for example, in a state in which the lower face 30b is in contact with the intermediate portion 5b. When the stator core 40 is mounted on the base protrusion portion 5d, the stator core 40 is fit to the base protrusion portion 5d such that the stator core 40 comes in contact with the upper face 30a of the core supporter 30. Thus, the stator core 40 is held by the core supporter 30.

A base hole 4d is formed in the bottom portion 4a of the chassis 4 in the form of a through hole with the rotational axis R as the center. The outer portion 5c of the base 5 is inserted into the base hole 4d so as to fix the base 5 to the chassis 4. A ring-shaped protrusion portion 4e is formed on the circumference of the base hole 4d such that it protrudes inward along the radial direction. When the outer portion 5c is fitted into the base hole 4d, the outer portion 5c is inserted into the base hole 4d until an upper face 5j of the outer portion 5c comes in contact with a lower face 4f of the protrusion portion 4e. This results in comparatively easy positioning of the base 5 with respect to the chassis 4 in the axial direction.

The housing 46 is fixed to a through hole 5k formed in the inner portion 5a with the rotational axis R as the center. The housing 46 has a cylindrical portion 46a and a bottom portion 46b monolithically configured in the form of a bottomed cup. The housing 46 is fixed to the base 5 such that the bottom portion 46b is positioned on the lower side.

The sleeve 44 is configured as a cylindrical member which is fixed to an inner face 46c of the cylindrical portion 46a of the housing 46 by means of adhesion, for example. The sleeve 44 is arranged such that it surrounds the shaft 26 via the lubricant agent 52. A flange space 60 is defined between a lower face 44b of the sleeve 44 and an upper face 46d of the bottom portion 46b of the housing 46, which houses the flange portion 26a of the shaft 26.

An extension portion 44a is formed at the upper end of the sleeve 44 such that it extends outward in the radial direction. A first thrust dynamic pressure generating groove 74 is formed in the upper face of the sleeve 44 including the upper face of the extension portion 44a as described later. Thus, by providing the extension portion 44a, such an arrangement allows the first thrust dynamic pressure generating groove 74 to be formed at a position that is comparatively farther from the rotational axis R, thereby providing the bearing with improved rigidity.

The gap between a part of the rotor, i.e., the shaft 26 and the hub 28, and a part of the stator, i.e., the sleeve 44 and the housing 46, is filled with the lubricant agent 52. The lubricant agent 52 contains a fluorescent material. When predetermined light such as ultraviolet light is irradiated to the lubricant agent 52, the lubricant agent 52 emits light having a wavelength that is different from the incident light, e.g., blue or green light, due to the interaction between the fluorescent material and the incident light. The manufacturing process for the rotating device 100 may include an inspection step in which predetermined light is irradiated to the liquid surface of the lubricant agent 52, and the light emitted from the fluorescent material contained in the lubricant agent 52 is detected so as to check the position of the liquid surface of the lubricant agent 52. Also, the manufacturing process may include a step in which predetermined light is irradiated to the rotating device 100 after it is assembled, and the light emitted from the fluorescent material contained in the lubricant agent 52 is detected so as to check for leakage of the lubricant agent 52.

A tapered sealing portion 56 is formed between a downward protruding portion 28c and the housing 46 such that a gap 54 between an inner face 28i of the downward protruding portion 28c and an upper outer face 46e of the housing 46 gradually extends as it approaches the lower side. Specifically, the downward protruding portion 28c is configured such that its inner face 28i is arranged approximately in parallel with the rotational axis R, and the upper outer face 46e of the housing 46 is configured to have a diameter that is smaller as it approaches the upper side, thereby providing the tapered sealing portion 56 with a tapered shape. The tapered sealing portion 56 has a gas-liquid interface 58 of the lubricant agent 52. That is to say, the gas-liquid interface 58 of the lubricant agent 52 is in contact with both the inner face 28i of the downward protruding portion 28c and the upper outer face 46e of the housing 46. The tapered sealing portion 56 prevents the lubricant agent 52 from leaking out using the capillary action.

A pair of a first radial dynamic pressure generating groove 68 and a second radial dynamic pressure generating groove 70 each having a herringbone structure or otherwise a spiral structure are formed in the inner face 44d of the sleeve 44 such that they are arranged so as to be separated from each other in the vertical direction. The first radial dynamic pressure generating groove 68 is formed on the upper side of the second radial dynamic pressure generating groove 70. The first radial dynamic pressure generating groove 68 may be formed in the outer face 26b of the shaft 26 instead of or in addition to the inner face 44d of the sleeve 44. Similarly, the second radial dynamic pressure generating groove 70 may be formed in the outer face 26b of the shaft 26 instead of or in addition to the inner face 44d of the sleeve 44.

The first thrust dynamic pressure generating groove 74 having a herringbone structure or otherwise a spiral structure is formed in the upper face 44c of the sleeve 44. The first thrust dynamic pressure generating groove 74 may be formed in the lower face 28j of the hub protrusion portion 28a instead of or in addition to the upper face 44c of the sleeve 44.

A second thrust dynamic pressure generating groove 78 having a herringbone structure or otherwise a spiral structure is formed in an upper face 26c of the flange portion 26a. The second thrust dynamic pressure generating groove 78 may be formed in the lower face 44b of the sleeve 44 instead of or in addition to the upper face 26c of the flange portion 26a.

A third thrust dynamic pressure generating groove having a herringbone structure or otherwise a spiral structure is formed in a lower face 26d of the flange portion 26a. The third thrust dynamic pressure generating groove 82 may be formed in the upper face 46d of the bottom portion 46b of the housing 46 instead of or in addition to the lower face 26d of the flange portion 26a.

When the rotor is rotated with respect to the stator, dynamic pressure is generated and applied to the lubricant agent 52 by means of the first radial dynamic pressure generating groove 68, the second radial dynamic pressure generating groove 70, the first thrust dynamic pressure generating groove 74, the second thrust dynamic pressure generating groove 78, and the third thrust dynamic pressure generating groove 82. By applying such dynamic pressure thus generated, the rotor is supported in a contactless manner both radially and axially with respect to the stator.

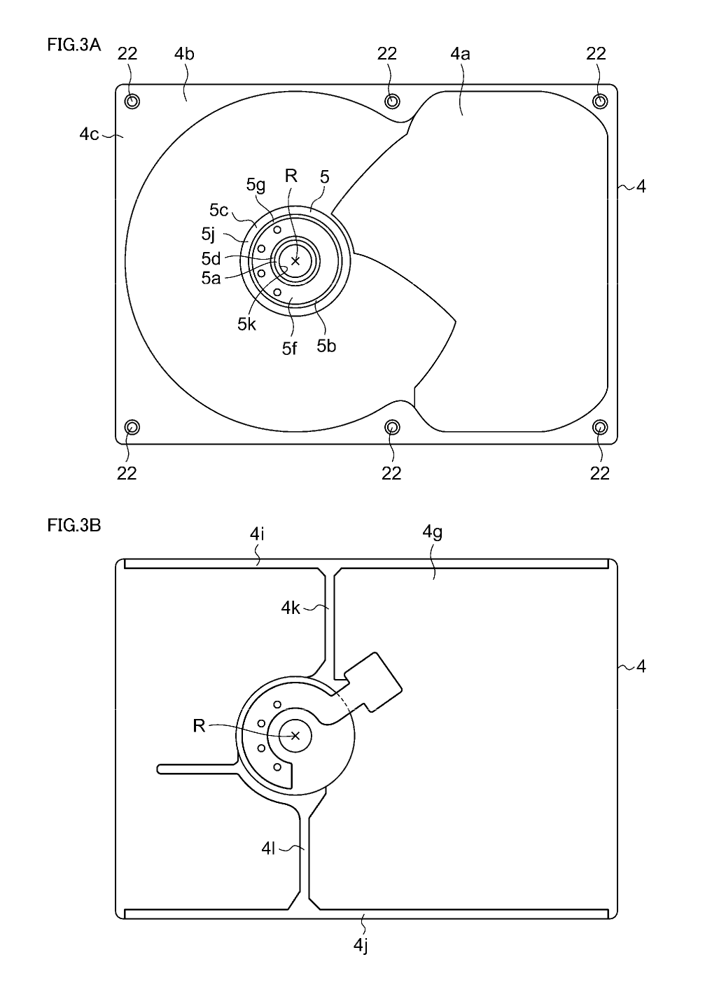

FIGS. 3A and 3B show the chassis 4 and the base 5. FIG. 3A shows a top view of the chassis 4 and the base 5. FIG. 3B is a bottom view of the chassis 4 and the base 5. A lower face 4g of the bottom portion 4a is provided with: a first rib 4i configured such that it extends along one long side of the bottom portion 4a; a second rib 4j configured such that it extends along the other long side; a third rib 4k configured such that it extends in a direction that is approximately orthogonal to the first rib 4i, and a fourth rib 4l configured such that it extends in a direction that is approximately orthogonal to the second rib 4j. At least one of the third rib 4k and the fourth rib 4l is formed on the side that is closer to the data read/write unit 10 than the rotational axis R. In the present embodiment, both the third rib 4k and the fourth rib 4l are formed on the side that is closer to the data read/write unit 10 than the rotational axis R.

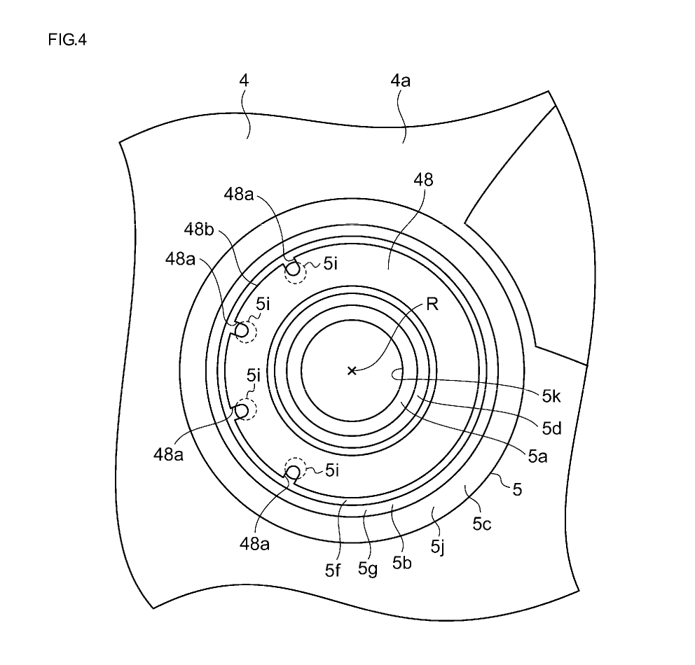

FIG. 4 is a top view showing the base 5 and its surroundings. FIG. 4 shows a state in which the insulator sheet 48 is bonded to the base 5. The four wire holes 5i are formed at regular intervals along the circumferential direction. With the present embodiment, the wire holes 5i are formed at intervals of 40 degrees along the circumferential direction. It should be noted that the intervals of the wire holes 5i are not restricted to such an arrangement. Also, the wire holes 5i may be formed at desired intervals along the circumferential direction. The wire holes 5i are formed on a side that is farther from the data read/write unit 10 than the rotational axis R.

The insulator sheet 48 has a ring-shaped structure. The insulator sheet 48 is provided with notches 48a formed at respective positions that correspond to the four wire holes 5i, i.e., at respective positions above the four wire holes 5i. Each notch 48a is formed by cutting out the insulator sheet 48 in the radial direction from its outer edge 48b side.

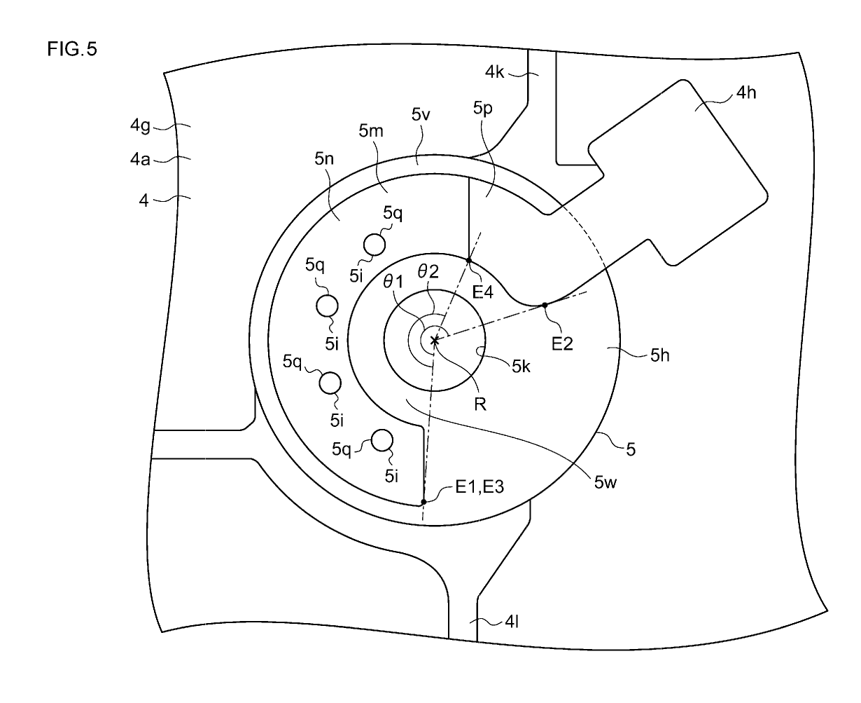

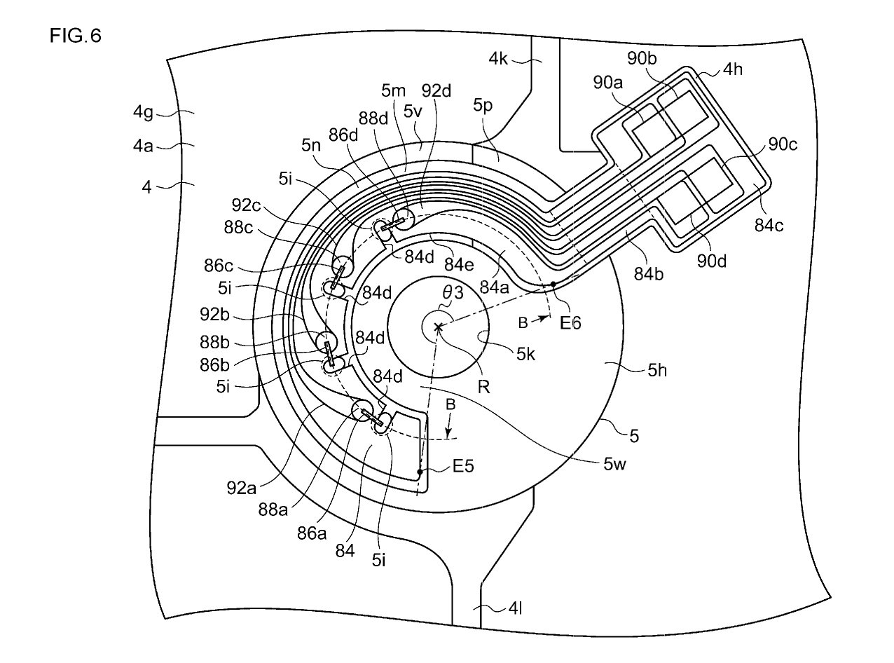

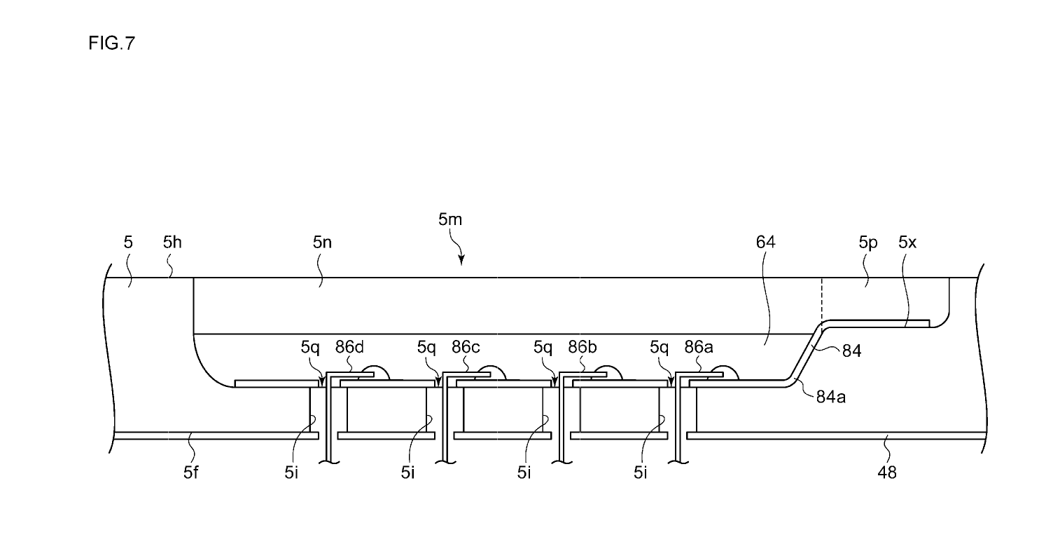

FIGS. 5 and 6 are bottom views showing the base 5 and its surroundings. FIG. 5 shows a state before the FPC 84 is bonded to the base 5. FIG. 6 shows a state after the FPC 84 is bonded to the base 5. FIG. 7 is a cross-sectional view taken along the line B-B in FIG. 6, i.e., a cross-sectional view of the base 5 taken along a circumferential line that passes through the center of each wire hole 5i. The bottom recess portion 5m has an arc-shaped structure as viewed in a plan view. The bottom recess portion 5m is configured to have regions that face each other across the rotational axis R. Specifically, the bottom recess portion 5m is formed such that it extends in the circumferential direction over an angle range of 180 degrees to 330 degrees with the rotational axis R as the center. Here, the angle range over which the bottom recess portion 5m extends in the circumferential direction is represented by an angle θ1 between the line that passes through the rotational axis R and one end E1 of the bottom recess portion 5m in the circumferential direction and the line that passes through the rotational axis R and the other one end E2 of the bottom recess portion 5m in the circumferential direction.

The bottom recess portion 5m includes a first recess portion 5n and a second recess portion 5p arranged continuously in the circumferential direction. The first recess portion 5n has a greater recess in the vertical direction than that of the second recess portion 5p. That is to say, the first recess portion 5n is configured with a depth that is greater than that of the second recess portion 5p. The first recess portion 5n is formed such that it extends in the circumferential direction over an angle range between 150 degrees and 210 degrees with the rotational axis R as the center. Here, the angle range over which the first recess portion 5n extends in the circumferential direction is represented by an angle θ2 between the line that passes through the rotational axis R and one end E3 of the first recess portion 5n in the circumferential direction and the line that passes through the rotational axis R and the other end E4 of the first recess portion 5n in the circumferential direction. Each opening 5q of the multiple wire holes 5i on the lower face 5h side is formed in the bottom of the first recess portion 5n. The second recess portion 5p is formed on a side that is closer to the data read/write unit 10 than the rotational axis R. The second recess portion 5p has a portion that faces a part of the first recess portion 5n across the rotational axis R.

The bottom recess portion 5m is provided with surface coating by means of resin coating such as epoxy resin coating. Also, such surface coating may be plating coating formed by plating the bottom recess portion 5m with a metal material such as nickel, chrome, or the like. In contrast, the top portion of an outer wall 5v that defines the bottom recess portion 5m may be configured as an uncoated face having no surface coating. At least one of the top portion of the outer wall 5v and the end face of the inner wall 5w may be configured as an uncoated surface, e.g., a cut surface obtained by removing the surface coating.

A chassis recess portion 4h is formed in the lower face 4g of the bottom portion 4a of the chassis 4 such that it communicates with the second recess portion 5p of the bottom recess portion 5m. Specifically, the chassis recess portion 4h is formed at a position that avoids its being positioned in a region of the bottom portion 4a that faces the data read/write unit 10 in the axial direction. Such a region of the bottom portion 4a that faces the data read/write unit 10 in the axial direction is formed with a comparatively small thickness. Thus, by forming the chassis recess portion 4h at a position that avoids its being positioned in such a region, such an arrangement suppresses a reduction in the rigidity of the bottom portion 4a.

The FPC 84 includes an arc portion 84a having an approximately arc shape, an extension portion 84b configured such that it extends outward in the radial direction from the outer perimeter of one end of the arc portion 84a that extends along the circumferential direction, and a power supply portion 84c arranged on the outer side of the extension portion 84b in the radial direction, and which is to be connected to an external power supply (not shown) or the like. The FPC 84 is formed in a question mark shape as viewed in a plan view.

The arc portion 84a is configured to have regions that face each other across the rotational axis R. More specifically, the arc portion 84a is formed such that it extends in a circumferential direction over an angle range between 180 degrees and 330 degrees with the rotational axis R as the center. Here, the angle range over which the arc portion 84a extends in the circumferential direction is represented by an angle θ3 between the line that passes through the rotational axis R and one end E5 of the arc portion 84a in the circumferential direction and the line that passes through the rotational axis R and the other end E6 of the arc portion 84a in the circumferential direction. The arc portion 84a is housed in the bottom recess portion 5m.

The arc portion 84a is provided with notches 84d formed at respective positions that correspond to the four wire holes 5i, i.e., at respective positions below the four wire holes 5i. Each notch 84d is formed by cutting the arc portion 84a outward in the radial direction from its inner edge 84e side. The lead wire 86 is drawn out on the lower face 5h side via the corresponding notch 48a formed in the insulator sheet 48, the corresponding wire hole 5i, and the corresponding notch 84d formed in the FPC 84. FIGS. 6 and 7 each show an example in which four lead wires 86a, 86b, 86c, and 86d, which respectively correspond to the U phase, V phase, W phase, and a common line, are drawn out on the lower face 5h side.

The arc portion 84a is provided with four connection lands 88a, 88b, 88c, and 88d. Specifically, the four connection lands 88a through 88d are each arranged separated from a corresponding wire hole 5i in the circumferential direction. In the present embodiment, the four connection lands 88a through 88d are each provided along the circumferential direction on the same side of the wire holes 5i. The four lead wires 86a through 86d, which are drawn out on the lower face 5h side, are each bent above the corresponding wire hole 5i such that they extend in the circumferential direction, and are each connected to the corresponding one of the connection lands 88a through 88d by soldering.

The four connection lands 88a, 88b, 88c, and 88d, are electrically connected to driving lines 92a, 92b, 92c, and 92d, respectively. The driving lines 92a, 92b, 92c, and 92d are arranged such that they extend from the arc portion 84a to the power supply portion 84c via the extension portion 84b. Furthermore, the driving lines 92a, 92b, 92c, and 92d are electrically connected to terminals 90a, 90b, 90c, and 90d, respectively, which are each provided to the power supply portion 84c.

An adhesion agent 64 is applied to the first recess portion 5n so as to cover the opening 5q of each wire hole 5i. This suppresses leak-in to the clean-air space 24 via each wire hole 5i and leak-out from the clean-air space 24 via each wire hole 5i. The adhesion agent 64 is applied in an upside-down state of the base 5, i.e., in a state in which the lower face 5h of the base 5 faces upward, as shown in FIG. 7. In this stage, an appropriate amount of the adhesion agent 64 is applied to the first recess portion 5n such that the adhesion agent 64 does not project toward the lower face 5h side (upper direction in FIG. 7) beyond a bottom portion 5x of the second recess portion 5p. Furthermore, the adhesion agent 64 is applied such that the wires 86a through 86d, which are each drawn out on the lower face 5h side, are not exposed. The adhesion agent 64 is applied to a region from the outer wall 5v up to the inner wall 5w so as to cover the bottom of the first recess portion 5n.

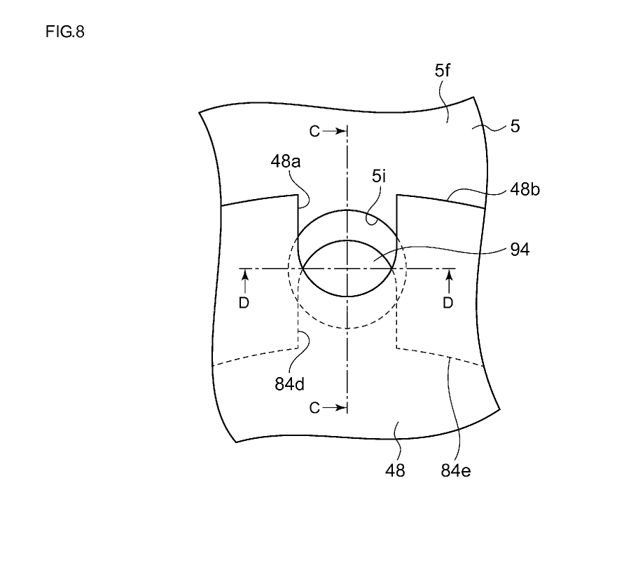

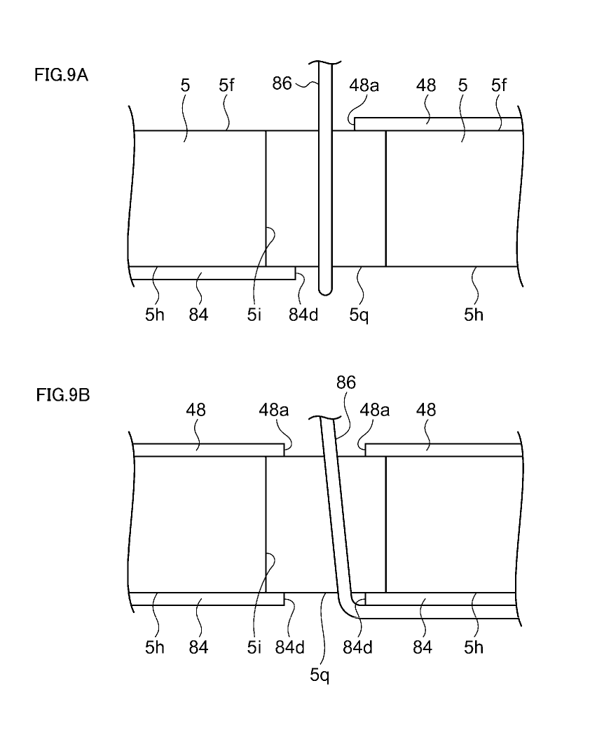

Next, description will be made regarding the relation between the notches 48a formed in the insulator sheet 48 and the notches 84d formed in the FPC 84. FIG. 8 is a top view showing the wire hole 5i and its surroundings. It can also be said that FIG. 8 is a view obtained by projecting the base 5, the insulator sheet 48, and the FPC 84 onto a plane that is orthogonal to the rotational axis R. FIG. 9A is a cross-sectional diagram taken along line C-C shown in FIG. 8. FIG. 9B is a cross-sectional diagram taken line D-D shown in FIG. 8.

As shown in FIG. 8, each notch 48a and the corresponding notch 84d are configured such that a region 94 surrounded by them is not obstructed by the base 5 in the axial direction. In other words, the notch 48a and the notch 84d are configured such that the region 94 surrounded by them is within the area of the wire hole 5i. In this case, as shown in FIGS. 9A and 9B, such an arrangement is capable of preventing the lead wire 86 and the base 5 from directly being in contact with each other. That is to say, such an arrangement allows the lead wire 86 to be drawn out on the lower face 5h side of the base 5 while maintaining the insulation between the base 5 and the lead wire 86 (i.e., coil 42). It should be noted that through holes may be formed in the insulator sheet 48 and the FPC 84, instead of such notches, which provides the same insulating effect. However, such an arrangement employing such notches allows the manufacturing costs to be suppressed for the insulator sheet 48 and the FPC 84.

Description will be made regarding the operation of the rotating device 100 configured as described above. In order to rotate the magnetic recording disk 8, 3-phase driving current is supplied to the coil 42 via the FPC 84. The driving current flows through the coil 42, which generates a magnetic flux along each of the nine salient poles. The magnetic fluxes thus generated apply a torque to the magnet 32, thereby rotating the hub 28 and the magnetic recording disk 8 fit to the hub 28. At the same time, the voice coil motor 16 swings the swing arm 14 so as to swing back and forth the record and playback head in the swinging range above the magnetic recording disk 8. The record and playback head converts magnetic data recorded on the magnetic recording disk 8 into an electrical signal, and transmits the electric signal thus converted to a control board (not shown). Furthermore, the record and playback head receives data transmitted in the form of an electric signal from the control board, and writes the data thus received on the magnetic recording disk 8 in the form of magnetic data.

With the rotating device 100 according to the present embodiment, the bottom recess portion 5m is configured to have regions that face each other across the rotational axis R. Thus, such an arrangement allows the wire holes 5i to be arranged at comparatively large intervals in the circumferential direction. This allows the connection lands 88a through 88d to be provided at respective positions away from the respective wire holes 5i in the circumferential direction.

It has been confirmed that, when each wire is connected to the corresponding connection land by soldering, by applying a soldering iron to the wire such that they come in contact in parallel with each other, such an arrangement provides reduced heating time required to raise the temperature of the wire, as compared with cases in which this is not done. This provides improved manufacturing efficiency. When the lead wires 86a through 86d are respectively connected to the connection lands 88a through 88d by soldering, the soldering iron is applied in parallel with the lead wire extending direction so as to solder the lead wires 86a through 86d. That is to say, in a case in which the lead wires 86a through 86d are arranged such that they extend toward the outer side in the radial direction, the soldering iron is applied for soldering from the outer side in the radial direction. In a case in which the connection lands are each arranged at an interval from the corresponding wire hole 5i in the radial direction, the lead wire 86 is arranged such that it extends from the wire hole 5i in the radial direction. Thus, in this case, the soldering iron is applied for soldering to each connection land along the radial direction. In this case, the outer wall 5v of the bottom recess portion 5m can interfere with the application of the soldering iron, which requires the soldering iron to be applied in an erect state. Such an arrangement requires long time required to raise the temperature of the wire, leading to reduced manufacturing efficiency. In contrast, with the present embodiment, the connection lands 88 are each arranged at an interval from the corresponding wire hole 5i in the circumferential direction. Furthermore, each lead wire 86 is arranged such that it extends in the circumferential direction from the corresponding wire hole 5i. With such an arrangement, the soldering iron is applied for soldering to each connection land 88 along the circumferential direction. In this case, interference does not easily occur between the outer wall of the bottom recess portion 5m and the soldering iron, thereby providing improved manufacturing efficiency.

It has been confirmed that, in a case in which the arc portion 84a is configured to have an angular range of 180 degrees or more, such an arrangement allows the connection lands 88 to each be arranged at an interval from the corresponding wire hole 5i along the circumferential direction. In a case in which the arc portion 84a is configured to have an angular range of 230 degrees or more, such an arrangement allows the connection lands 88a through 88d to be formed at increased intervals, thereby reducing the risk of the soldering iron coming in contact with an adjacent connection land when the soldering iron is applied to a given connection land. In a case in which the arc portion 84a is configured to have an angular range of 280 degrees or more, such an arrangement allows the connection lands 88a through 88d to be formed at increased intervals, thereby providing improved manufacturing efficiency in the wire terminal process. In a case in which the arc portion 84a is configured to have an angular range of 330 degrees or less, such an arrangement reduces the distance over which the soldering iron is to be moved for consecutive soldering of the lead wires 86a through 86d, thereby providing improved manufacturing efficiency.

In the rotating device 100 according to the present embodiment, the connection lands 88a through 88d are are configured on the same side of the wire holes 5i, and at an interval from the corresponding wire hole 5i in the circumferential direction. Thus, such an arrangement reduces the distance over which the soldering iron is to be moved for consecutive soldering of the lead wires 86a through 86d, thereby providing improved manufacturing efficiency.

In the rotating device 100 according to the present embodiment, the first recess portion 5n having the opening 5q of each wire hole 5i formed on the lower face 5h side is configured to have a greater depth than that of the second recess portion 5p that communicates with the chassis recess portion 4h. The adhesion agent 64 is applied to the first recess portion 5n so as to cover the opening 5q of each wire hole 5i. The adhesion agent 64 is applied in a state in which the lower face 5h of the base 5 faces upward. Specifically, an appropriate amount of the adhesion agent 64 is applied to the first recess portion 5n such that the adhesion agent 64 does not project toward the lower face 5h side beyond a bottom portion 5x of the second recess portion 5p. With such an arrangement, the adhesion agent 64 is blocked by a slope formed at a position between the first recess portion 5n and the second recess portion 5p, thereby suppressing the flow of the adhesion agent 64 to the second recess portion 5p and to the chassis 4. As described above, by forming the first recess portion 5n having the opening 5q so as to have a greater depth than that of the second recess portion 5p that communicates with the chassis recess portion 4h, such an arrangement is capable of suppressing the flow of the adhesion agent 64 to the chassis recess portion 4h.

In the rotating device 100 according to the present embodiment, the first rib 4i, the second rib 4j, the third rib 4k, and the fourth rib 4l are formed on the lower face 4g of the chassis 4. This provides improved rigidity of the chassis 4, and in particular provides improved rigidity of the chassis 4 in the vicinity of the rotational axis R.

Description has been made in the embodiment regarding the configuration and the operation of the rotating device according to the embodiment. The above-described embodiments have been described for exemplary purposes only, and are by no means intended to be interpreted restrictively. Rather, it can be readily conceived by those skilled in this art that various modifications may be made by making various combinations of the aforementioned components, which are also encompassed in the technical scope of the present invention. Also, a combination of different embodiments may be made.

### [Modification 1]

Description has been made in the embodiment regarding a so-called outer rotor type rotating device having a configuration in which the magnet 32 is arranged on the outer side of the stator core 40. However, the present invention is not restricted to such an arrangement. For example, the rotating device may be configured as a so-called inner rotor type rotating device having a configuration in which a magnet is arranged on the inner side of the stator core.

### [Modification 2]

Description has been made in the embodiment regarding an arrangement in which the stator core 40 includes nine salient poles. However, the present invention is not restricted to such an arrangement. The number of salient poles of the stator core 40 may be six, for example. Such an arrangement allows the coil 42 to be formed in a simpler manner. Also, the number of salient poles of the stator core 40 may be a multiple of 3 ranging between 12 and 36, for example. Such an arrangement provides the coil 42 with an increased number of turns.

### [Modification 3]

Description has been made in the embodiment regarding an arrangement in which the magnet 32 is configured such that 12 driving magnetic poles are formed. However, the present invention is not restricted to such an arrangement. Also, the number of driving magnetic poles formed on the magnet 32 may be an even number ranging between 8 and 16. Description has been made above for exemplary purposes only. That is to say, the number of driving magnetic poles is not restricted to such a range.

### [Modification 4]

The terms “SUS430”, “SUS303”, and “SUS420J2” in the aforementioned description in the embodiment each represent a kind of stainless steel according to the JIS standards. The kinds of stainless steel have been described in the embodiment for exemplary purposes only. The members formed of SUS430, SUS303, or SUS420J2 may be formed of other kinds of metal materials or resin materials instead of SUS430, SUS303, or SUS420J2 so long as they satisfy the design specifications.

### [Modification 5]

Description has been made in the embodiment regarding an arrangement in which the lead wire 86 is connected by soldering to the FPC 84 configured as a wiring member. However, the present invention is not restricted to such an arrangement. Also, other kinds of wiring members such as rigid printed circuit boards, connectors, or the like may be employed as a wiring member. Also, a hybrid member obtained by combining multiple wiring members may be employed as a wiring member. Also, other kinds of connection methods such as welding, adhesion, or the like may be employed instead of soldering.

### [Modification 6]

Description has been made in the embodiment regarding an arrangement in which the sleeve 44 is fixedly mounted on the base 5, and the shaft 26 is rotated together with the hub 28. However, the present invention is not restricted to such an arrangement. For example, an arrangement may be employed in which a shaft is fixedly mounted on a base, and a sleeve is rotated together with a hub.

### [Modification 7]

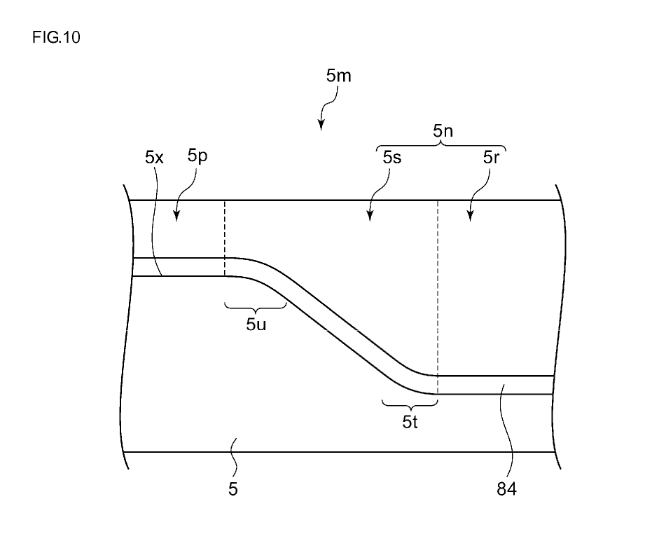

The bottom recess portion 5m may be configured such that the bottom of the first recess portion 5n is smoothly connected to the bottom of the second recess portion 5p, which has not been described in particular. FIG. 10 shows the bottom recess portion 5m according to such a modification. The bottom recess portion 5m includes the first recess portion 5n and the second recess portion 5p.

The first recess portion 5n includes a rectangular recess portion 5r and a connection recess portion 5s. The connection recess portion 5s smoothly connects the rectangular recess portion 5r and the second recess portion 5p, which have different depths. In the present embodiment, a connection portion 5t configured as a part of the bottom of the connection recess portion 5s, which is connected to the bottom of the rectangular recess portion 5r, is configured to have a curved face having a predetermined curvature. In this case, such an arrangement allows the FPC 84 to be in contact with the bottom of the rectangular recess portion 5r and the bottom of the connection recess portion 5s. Such an arrangement is capable of preventing air from entering the gap between the FPC 84 and the bottom of the rectangular recess portion 5r and the gap between the FPC 84 and the bottom of the connection recess portion 5s. It should be noted that the curvature of the connection portion 5t is determined based on the flexibility of the FPC 84. For example, the curvature of the connection portion 5t may preferably be determined by experiment. Similarly, a connection portion 5u configured as a part of the bottom of the connection recess portion 5s, which is connected to the bottom of the second recess portion 5p, is configured to have a curved face having a predetermined curvature. In this case, such an arrangement allows the FPC 84 to be in contact with the bottom of the second recess portion 5p and the bottom of the connection recess portion 5s. Such an arrangement is capable of preventing air from entering the gap between the FPC 84 and the bottom of the second recess portion 5p and the gap between the FPC 84 and the bottom of the connection recess portion 5s.

If there is a gap between the FPC 84 and the first recess portion 5n or the second recess portion 5p, and if air remains in such a gap, air bubbles will arise on the surface of the adhesion agent in a process in which the adhesion agent applied to the first recess portion 5n solidifies. This leads to bubble holes on the surface of the adhesion agent, resulting in a problem with its appearance. In contrast, the present modification allows the FPC 84 to be in contact with the bottom of the first recess portion 5n and the bottom of the second recess portion 5p. That is to say, such an arrangement suppresses the occurrence of a gap between the FPC 84 and the bottom of the first recess portion 5n or the bottom of the second recess portion 5p. This prevents air from entering the gap between the FPC 84 and the bottom of the first recess portion 5n or the bottom of the second recess portion 5p. Thus, such an arrangement suppresses the arising of bubble holes on the surface of the adhesion agent in a process in which the applied adhesion agent solidifies, thereby providing the rotating device with an improved appearance.

What is claimed is:

1. A rotating device comprising:
a hub on which a recording disk is to be mounted;
a base that rotatably supports the hub via a bearing,
a core fixedly mounted on the base, and having a circular portion and a plurality of salient poles each protruding radially outward from the circular portion;
a coil formed by winding a wire around the plurality of salient poles; and
a circuit board including a driving line,
wherein the base is provided with a wire hole that communicates between a first face that faces the coil in the axial direction and a second face that is opposite to the first face,
wherein the second face is provided with a surrounding recess portion having an arc region formed in an approximately arc shape, which is configured to surround a rotational axis of the hub and to have regions that face each other across the rotational axis,
wherein the circuit board comprises an arc section formed in an approximately arc shape, which is housed in the arc region,
and wherein a lead wire is drawn out from the coil to the second face side via the wire hole, and is connected to the driving line on a connection land formed in the arc section at an interval from the wire hole in a circumferential direction.

2. The rotating device according to claim 1, wherein the arc section is formed so as to extend over an angular range between 180 degrees and 330 degrees in the circumferential direction with the rotational axis as a center.

3. The rotating device according to claim 1, wherein the surrounding recess portion comprises a first recess portion and a second recess portion having a smaller depth than the depth of the first recess portion, which are formed continuously in the circumferential direction,
and wherein an opening of the wire hole is formed in the first recess portion.

4. The rotating device according to claim 3, wherein the first recess portion is formed so as to extend in the circumferential direction over an angular range between 150 degrees and 210 degrees with the rotational axis as a center.

5. The rotating device according to claim 1, wherein the second face includes a portion having an insulating layer on a surface in the vicinity of a top portion of an outer wall that defines the surrounding recess portion and at a position so as to avoid positioning at the top portion.

6. The rotating device according to claim 1, wherein the base comprises: a bottom portion having an approximately rectangular shape as viewed in a plan view, and having a region which is to be provided with a record and playback head; and a surrounding wall portion that protrudes from an edge of the bottom portion in the axial direction,
and wherein the wire hole is formed on a side farther from the region which is to be provided with the record and playback head than the rotational axis in a longitudinal direction of the bottom portion.

7. The rotating device according to claim 3, wherein the base comprises: a bottom portion having an approximately rectangular shape as viewed in a plan view, and having a region which is to be provided with a record and playback head; and a surrounding wall portion that protrudes from an edge of the bottom portion in the axial direction,
and wherein the second recess portion is formed on a side closer to the region which is to be provided with the record and playback head than the rotational axis in a longitudinal direction of the bottom portion.

8. The rotating device according to claim 6, wherein the bottom portion has a rib arranged on a side closer to the region which is to be provided with the record and playback head than the rotational axis in a longitudinal direction of the bottom portion.

9. A rotating device comprising:
a base that rotatably supports a rotor via a bearing,
a core fixedly mounted on the base, and having a circular portion and a plurality of salient poles each protruding radially outward from the circular portion;
a coil formed by winding a wire around the plurality of salient poles; and
a circuit board including a driving line,
wherein the base is provided with a wire hole that communicates between a first face that faces the coil in the axial direction and a second face that is opposite to the first face,
wherein the second face is provided with a surrounding recess portion having an arc region formed in an approximately arc shape, which is configured to surround a rotational axis of the rotor and to have regions that face each other across the rotational axis,
wherein the circuit board comprises an arc section formed in an approximately arc shape, which is housed in the arc region,
and wherein a lead wire is drawn out from the coil to the second face side via the wire hole, and is connected to the driving line on a connection land formed in the arc section at an interval from the wire hole in a circumferential direction.

10. The rotating device according to claim 9, wherein the arc section is formed so as to extend over an angular range between 180 degrees and 330 degrees in the circumferential direction with the rotational axis as a center.

11. The rotating device according to claim 9, wherein the surrounding recess portion comprises a first recess portion and a second recess portion having a smaller depth than the depth of the first recess portion, which are formed continuously in the circumferential direction,
and wherein an opening of the wire hole is formed in the first recess portion.

12. The rotating device according to claim 11, wherein the first recess portion is formed so as to extend in the circumferential direction over an angular range between 150 degrees and 210 degrees with the rotational axis as a center.

13. The rotating device according to claim 9, wherein the second face includes a portion having an insulating layer on a surface in the vicinity of a top portion of an outer wall that defines the surrounding recess portion and at a position so as to avoid positioning at the top portion.

14. The rotating device according to claim 9, wherein the base comprises: a bottom portion having an approximately rectangular shape as viewed in a plan view, and having a region which is to be provided with a record and playback head; and a surrounding wall portion that protrudes from an edge of the bottom portion in the axial direction,
and wherein the wire hole is formed on a side farther from the region which is to be provided with the record and playback head than the rotational axis in a longitudinal direction of the bottom portion.

15. The rotating device according to claim 11, wherein the base comprises: a bottom portion having an approximately rectangular shape as viewed in a plan view, and having a region which is to be provided with a record and playback head; and a surrounding wall portion that protrudes from an edge of the bottom portion in the axial direction,
and wherein the second recess portion is formed on a side closer to the region which is to be provided with the record and playback head than the rotational axis in a longitudinal direction of the bottom portion.

16. The rotating device according to claim 14, wherein the bottom portion has a rib arranged on a side closer to the region which is to be provided with the record and playback head than the rotational axis in a longitudinal direction of the bottom portion.

17. A rotating device comprising:
a base that rotatably supports a rotor via a bearing, and
a circuit board fixedly mounted on the base,
wherein the base is provided with a through hole that communicates between a first face and a second face that is opposite to the first face,
wherein the second face is provided with a surrounding recess portion having an arc region formed in an approximately arc shape, which is configured to surround a rotational axis of the rotor and to have regions that face each other across the rotational axis,
wherein the surrounding recess portion comprises a first recess portion and a second recess portion having a smaller depth than the depth of the first recess portion, which are formed continuously in the circumferential direction,
wherein an opening of the through hole is formed in the first recess portion,
wherein the circuit board comprises an arc section formed in an approximately arc shape, which is housed in the arc region,
and wherein the circuit board is provided with a connection land arranged at an interval from the through hole in a circumferential direction.

18. The rotating device according to claim 17, wherein the arc section is formed so as to extend over an angular range between 180 degrees and 330 degrees in the circumferential direction with the rotational axis as a center,
and wherein the first recess portion is formed so as to extend in the circumferential direction over an angular range between 150 degrees and 210 degrees with the rotational axis as a center.

19. The rotating device according to claim 17, wherein the second face includes a portion having an insulating layer on a surface in the vicinity of a top portion of an outer wall that defines the surrounding recess portion and at a position so as to avoid positioning at the top portion.

20. The rotating device according to claim 17, wherein the base comprises: a bottom portion having an approximately rectangular shape as viewed in a plan view, and having a region which is to be provided with a record and playback head; and a surrounding wall portion that protrudes from an edge of the bottom portion in the axial direction,
and wherein the wire hole is formed on a side farther from the region which is to be provided with the record and playback head than the rotational axis in a longitudinal direction of the bottom portion.
